(19) United States
(12) Patent Application Publication
(10) Pub. No.: US 2009/0316127 A1
(43) Pub. Date: Dec. 24, 2009

(54) SUBSTRATE, AND METHOD AND APPARATUS FOR PRODUCING THE SAME

(75) Inventor: Toshikazu FURUI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/394,980

(22) Filed: Feb. 27, 2009

(30) Foreign Application Priority Data
Jun. 23, 2008 (JP) 2008-162743

(51) Int. Cl. G03B 27/52

(52) U.S. Cl. 355/61

(57) ABSTRACT

A method, for producing a substrate, includes: forming an alignment mark on a first surface of the substrate; detecting a position of the alignment mark; forming a mark by scanning and focusing a laser beam on a position, on a second surface of the substrate, corresponding to the position of the alignment mark, the laser beam having a wavelength so as to pass through the substrate.

### CROSS-REFERENCE TO RELATED APPLICATION

This application is based upon and claims the benefit of priority of the prior Japanese Patent Application No. 2008-162743, filed on Jun. 23, 2008, the entire contents of which are incorporated herein by reference.

### FIELD

The embodiments discussed herein are related to a substrate, and a method and an apparatus for producing the substrate.

### BACKGROUND

Conventionally, there has been known a technique for forming resist patterns on both surfaces of a substrate. There has been known the following representative examples. First, the resist pattern including an alignment mark is formed on a first surface of the substrate. Next, a mask on which the alignment mark is lithographed is arranged to face the second surface of the substrate. Herein, the alignment mark, formed on the first surface of the substrate, and the alignment mark, lithographed in the mask, are overlapped to be aligned with each other. Then, a second surface of the substrate is exposed, so that the resist patterns are formed on both surfaces of the substrate. Additionally, the alignment of the position of the alignment mark formed on the first surface of the substrate and that of the alignment mark formed on the mask are achieved by detecting by using cameras, which are separately provided on each side of the substrate.

Further, Patent Document 1 (Japanese Laid-open Patent Publication No. 2004-45933) discloses a technique relating to the hollowing formation of the resist pattern. The position of the alignment mark formed on the first surface of the substrate is detected from the second surface of the substrate by using lights with wavelengths that pass through the substrate, so the alignment mark is aligned with the alignment mark lithographed on the mask. Next, the second surface of the substrate is exposed to form the resist pattern.

Additionally, Patent Document 2 (Japanese Laid-open Patent Publication No. 60-146684) discloses a technique relating to the marking below. A pair of optical fibers is arranged on both surfaces of the substrate, respectively. The laser beams are irradiated to the substrate from the pair of optical fibers, thereby marking at the same positions on the both surfaces of the substrate.

However, in the conventional techniques, the position of the alignment mark formed on the first surface of the substrate and the position of the alignment mark lithographed on the mask are detected by separate cameras. For this reason, the equipment cost is increased.

Further, in a case where a nontransparent layer is formed on either of the surfaces of the substrate, the alignment mark formed on the first surface of the substrate cannot be recognized from the second surface by the technique disclosed in Patent Document 1. This also applies to a case where mirror finishing is not processed on the first surface of the substrate. Hence, the technique disclosed in Patent Document 1 cannot be applied to a wide variety of substrates and lacks versatility.

In the technique disclosed in Patent Document 2, the alignment of a pair of optical fibers is performed by detecting a laser beam which is irradiated from one of the optical fibers and then enters into the other of the optical fibers. This alignment is accomplished by the movement of stages respectively supporting the optical fibers. Further, at least two alignment marks have to be formed on the substrate. Therefore, the alignment of the pair of the optical fibers is required, whenever there is a change in a marking position on the substrate. Since at least two alignment marks have to be formed, the laser beam is irradiated twice. Thus, the technique disclosed in Patent Document 2 increases the number of manufacturing processes.

### SUMMARY

A method for producing a substrate, disclosed herein, includes: forming an alignment mark on a first surface of the substrate; detecting a position of the alignment mark; and forming a mark by scanning and focusing a laser beam on a position, on a second surface of the substrate, corresponding to the position of the alignment mark, the laser beam having a wavelength so as to pass through the substrate.

Since the alignment mark formed on both surfaces of the substrate is simply detected, detecting means for independently detecting each of the both surfaces of the substrate can be eliminated. Therefore, the substrate can be produced at a low cost. Additionally, since the mark is formed by focusing the laser beam on the second surface of the substrate, even when the second surface is provided with a nontransparent layer or the second surface is not processed by mirror finishing, the mark can be formed. Hence, the mark can be formed on a wide variety of substrates, thereby achieving superiority in general use. Further, since the mark is formed by scanning the laser beam, each of the positioning process for positioning the irradiation position of the laser beam and the irradiation process for irradiating the laser beam is performed only once. This reduces the number of the processes.

Further, an apparatus for producing a substrate, disclosed herein, includes: a camera detecting an alignment mark formed on a first surface of the substrate; a laser oscillator irradiating a laser beam having a wavelength so as to pass through the substrate; a lens focusing the laser beam on a position, on a second surface of the substrate, corresponding to a position of the alignment mark; and a stage holding the substrate for movement and scanning a focused position of the laser beam relative to the substrate.

Furthermore, a substrate produced by the method or the apparatus mentioned above includes: a first surface; a second surface; alignment marks respectively formed on the first surface and the second surface, and a laser mark formed to overlap the alignment marks.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIGS. 1A and 1B are explanatory views of a method for forming the resist patterns on both surfaces of a substrate;

FIGS. 2A and 2B are explanatory views of the method for forming the resist patterns on both surfaces of a substrate;

FIGS. 3A to 3C are explanatory views of the method for forming the resist patterns on both surfaces of a substrate;

FIG. 4 is an explanatory view schematically illustrating a producing apparatus of the substrate;

FIGS. 5A and 5B are explanatory views of a state of the laser beam focused on a second surface of the substrate;

FIG. 6 is a functional block view of a laser irradiation unit; and

FIGS. 7A and 7B are views of the substrate after the laser irradiation.

### DESCRIPTION OF EMBODIMENTS

A description will be given of embodiments with reference to the accompanying drawings.

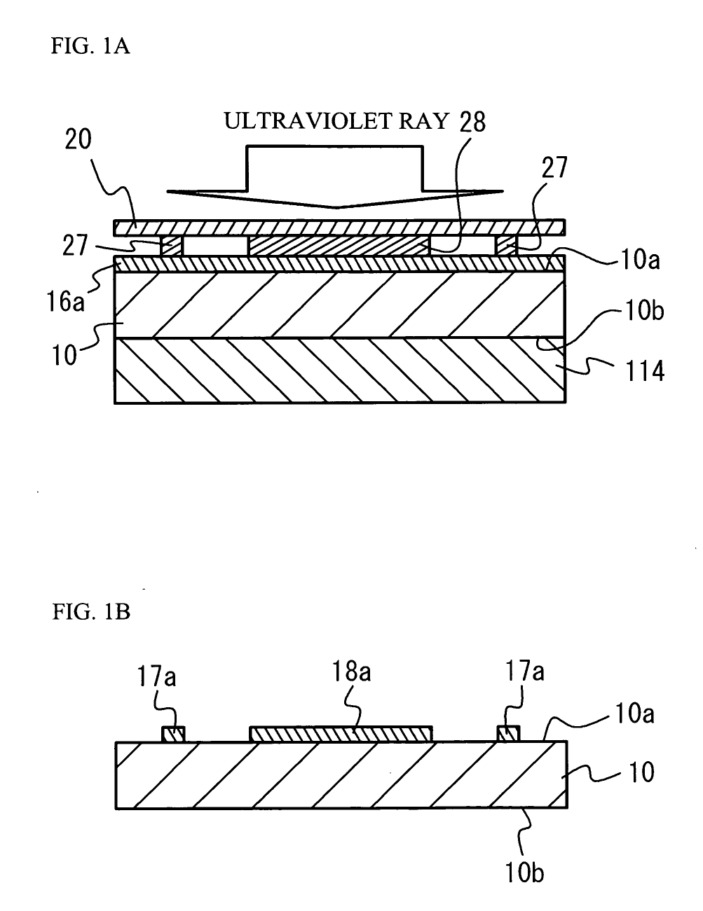

A description will be given of a method for forming resist pattern on both surfaces of a substrate. FIGS. 1A to 3C are explanatory views of the method for forming the resist patterns on both surfaces of a substrate.

A substrate 10 is a silicon substrate which is employed in MEMS (Micro Electro Mechanical Systems) or the like. First, a description will be given of a method for forming a resist pattern on a first surface 10a of the substrate 10. As depicted in FIG. 1A, the substrate 10 in which a resist 16a is applied to the first surface 10a is set on a θ stage 114. Next, a mask 20, in which an alignment mark 27 and a resist pattern 28 are lithographed, is set to face the resist 16a. Then, the resist 16a is irradiated with ultraviolet rays to be exposed to light. When an image is developed, an alignment mark 17a and a resist pattern 18a are formed on the first surface 10a of the substrate 10. In this manner, the method for forming the resist pattern on the first surface 10a is as with the conventional method.

Next, a description will be given of a process for forming the mark on a second surface 10b of the substrate 10. The position of the alignment mark 17a formed on the first surface 10a of the substrate 10 is detected by a mark detecting camera 240 arranged above the first surface 10a. The detection of the position of the alignment mark 17a by the mark detecting camera 240 is assured by a difference in optical reflectivity in the proximity of the alignment mark 17a. Next, by using a laser oscillator or the like, which is arranged above the first surface 10a, as with the mark detecting camera 240, a laser beam L is focused to a position, of the second surface 10b of the substrate 10, corresponding to the position of the alignment mark 17a. In addition, a wavelength of the laser beam L is set such that the laser beam L passes through the substrate 10. Preferably, the wavelength of the laser beam L is 0.185-2.5 mm in a quartz substrate, that of the laser beam L is 0.18-4.5 mm in a sapphire substrate, and that of the laser beam L is 1.2-7.0 mm in a silicon substrate.

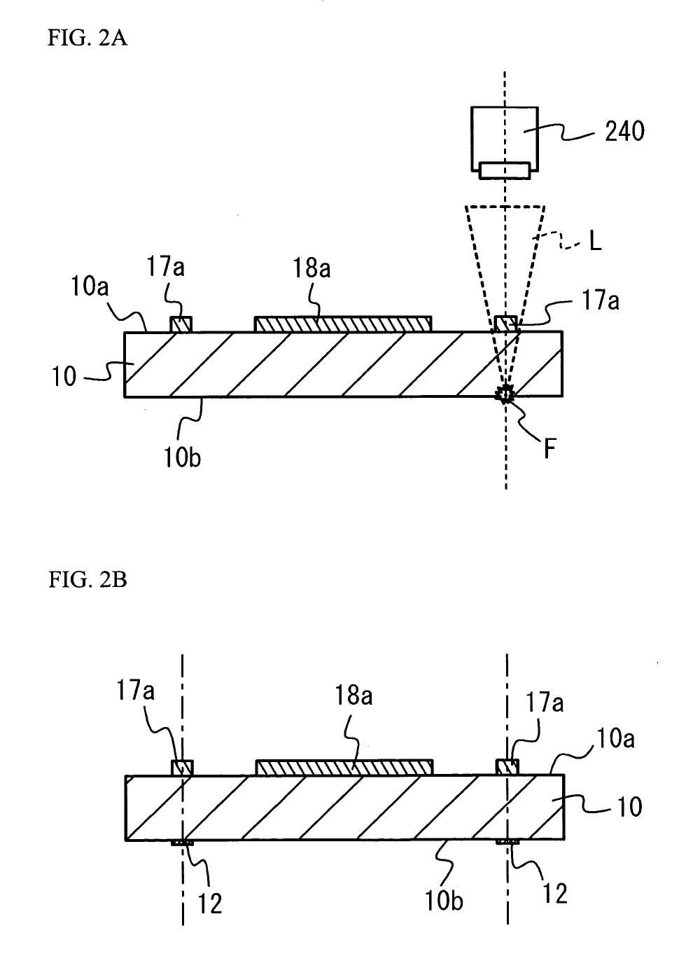

Next, the laser beam L is scanned along the alignment mark 17a. More specifically, by moving a state not illustrated, which holds the substrate 10, the laser beam L is scanned along the alignment mark 17a. Thus, a light focus point F moves along the alignment mark 17a. Therefore, the laser mark is formed on the second surface 10b of the substrate 10 so as to correspond to the alignment mark 17a, as illustrated in FIG. 2B.

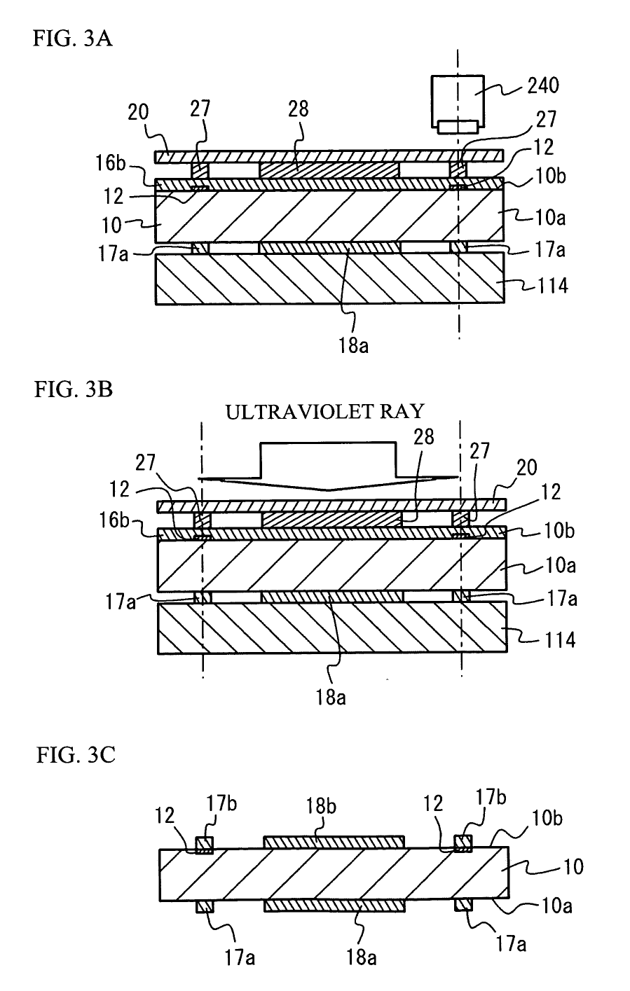

Next, a description will be given of a process for forming the resist patter on the second surface 10b of the substrate 10. Referring to FIG. 3A, the substrate 10, in which a resist 16b is applied to the second surface 10b, is reversed such that the second surface 10b faces upwardly, and then is set on the θ stage 114. Further, the mask 20 is set to face the second surface 10b. Then, a position of a mark 12 formed on the second surface 10b is detected by the mark detecting camera 240. Further, since the resist 16b is transmissive to some extent, even when the resist 16b is applied to the second surface 10b, the position of the mark 12 can be detected by the mark detecting camera 240.

Next, the mark 12 and the alignment mark 27 are positioned by moving the substrate 10 so that the mark and the alignment mark 27 are overlapped. Next, an ultraviolet ray is irradiated to the second surface 10b of the substrate 10 to be exposed, as illustrated in FIG. 3B. After this, the development is performed, thereby forming an alignment mark 17b and a resist pattern 18b on the second surface 10b of the substrate 10, too, as illustrated in FIG. 3C. Therefore, the resist pattern is formed on the both surfaces of the substrate 10. Additionally, after the resist pattern is formed on the both surfaces of the substrate 10, an etching process and a resist removing process are performed, so that the substrate is produced which is employed in an electronic device such as MEMS.

As stated above, the positions of the mark 12 and the alignment mark 27 can be detected by the single mark detecting camera 240. Namely, the resist pattern can be formed on the both surface of the substrate 10 by the single mark detecting camera 240 with accuracy. Accordingly, the method for producing the substrate, according to the present embodiment, is achieved at a low cost.

In addition, even when a nontransparent layer such as a metallic layer is formed on the second surface 10b of the substrate 10, the mark 12 can be formed at an exact position of the second surface 10b with the alignment mark 17a used as a reference. Therefore, the resist pattern can be formed on the surface of the nontransparent layer with accuracy with the mark 12 formed on the nontransparent layer used as a reference. This applies to a case where the second surface 10b is not processed with mirror finishing. As above stated, the resist pattern can be formed on both surfaces of a wide variety of substrates. Accordingly, the method for producing the substrate, according to the present embodiment, is superiority in general use.

Only one process for positioning the irradiated position subject to the laser beam is necessary, the alignment mark 17a is used as a reference. The mark on the second surface 10b is formed with the alignment mark 17a used as a reference already formed on the first surface 10a, whereby the mark, which has the same shape of the alignment mark 17a, is formed on the second surface 10b by only one process by simply scanning the laser beam L. In this way, the method according to the present embodiment reduces the number of the processes.

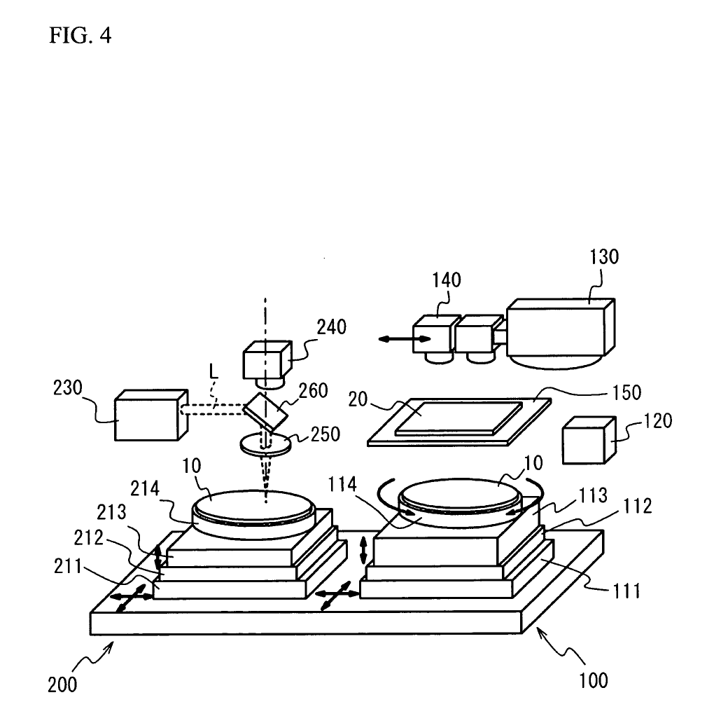

Next, a description will be given of a producing apparatus used to perform the method for producing the substrate described above. FIG. 4 is an explanatory view schematically illustrating the producing apparatus of the substrate. As illustrated in FIG. 4, in the producing apparatus of the substrate, an alignment exposure unit 100 and a laser irradiation unit 200 are integrated.

The alignment exposure unit 100 is provided for exposing the substrate 10. The alignment exposure unit 100 includes an X stage 111, a Y stage 112, a Z stage 113, the θ stage 114, a vacuum pump 120, an exposure lamp 130, an alignment camera 140, and a mask holder 150. The X stage 111, the Y stage 112, the Z stage 113, and the θ stage 114 can move the substrate 10 in the left-right direction in figures, in the front-rear direction, in the upper-lower direction, in the rotational direction, respectively. The X stage 111, the Y stage 112, the Z stage 113, and the θ stage 114 are moved by an actuator such as a pulse motor. The Y stage 112 is arranged above the X stage 111, the Z stage 113 is arranged above the Y stage 112, and the θ stage 114 is arranged above the Z stage 113.

The vacuum pump 120 is provided for attaching the substrate 10 on the θ stage 114 by generating a negative pressure for the substrate 10. The pressure generated by the vacuum pump 120 switches from the negative pressure to zero pressure or positive pressure, thereby releasing the attachment of the substrate 10 on the θ stage 114.

The exposure lamp 130 is provided for irradiating ultraviolet rays to expose the substrate 10. The alignment camera 140 is provided for detecting the position of the substrate 10 relative to the mask 20. A position coordinate is calculated by a control unit not illustrated on the basis of data outputted from the alignment camera 140. The mask holder 150 is provided for holding the mask 20 and is attached in a predetermined position. The movements of the X stage 111, the Y stage 112, the Z stage 113, and the θ stage 114 allow the substrate 10 to move to a desired position relative to the mask 20, and the substrate 10 can be exposed.

Next, a description will be given of the laser irradiation unit 200. Referring now to FIG. 4, the laser irradiation unit 200 includes an X stage 211, a Y stage 212, a Z stage 213, a substrate holder 214, a laser oscillator 230, the mark detecting camera 240, a collective lens 250, and a dichroic mirror 260.

The X stage 211, the Y stage 212, and the Z stage 213 can move the substrate 10 in the left-right direction in figures, in the front-rear direction, in the upper-lower direction, respectively. The X stage 211, the Y stage 212, and the Z stage 213 are moved by an actuator such as a pulse motor. The Y stage 212 is arranged above the X stage 211, and the Z stage 213 is arranged above the Y stage 212.

The substrate holder 214 is provided for holding the substrate 10 as a processing object. The substrate holder 214 is arranged above the Z stage 213. The driving of the X stage 211, the Y stage 212, and the Z stage 213 allows the substrate holder 214 to move to position the substrate 10 at a desired position.

The laser oscillator 230 irradiates the laser beam to the second surface 10b of the substrate 10 to form the mark. Specifically, the laser beam irradiated from the laser oscillator 230 is reflected by the dichroic mirror 260 and guided to the substrate 10. The laser beam reflected by the dichroic mirror 260 is focused on the second surface 10b of the substrate 10 by the collective lens 250.

The mark detecting camera 240 detects the position of the alignment mark 17a formed on the first surface 10a of the substrate 10. Referring now to FIG. 4, the mark detecting camera 240, the collective lens 250, and the dichroic mirror 260 are fixedly and coaxially arranged. Namely, the dichroic mirror 260 is arranged on the optical axis of the mark detecting camera 240. The dichroic mirror 260 reflects the laser passing through the substrate 10, but does not reflect other lights. For this reason, even when the mark detecting camera 240 and the dichroic mirror 260 are arranged coaxially, the position of the alignment mark 17a can be detected. That is, the provision of the dichroic mirror 260 allows the laser oscillator 230 to be arranged at a position other than the optical axis of the mark detecting camera 240.

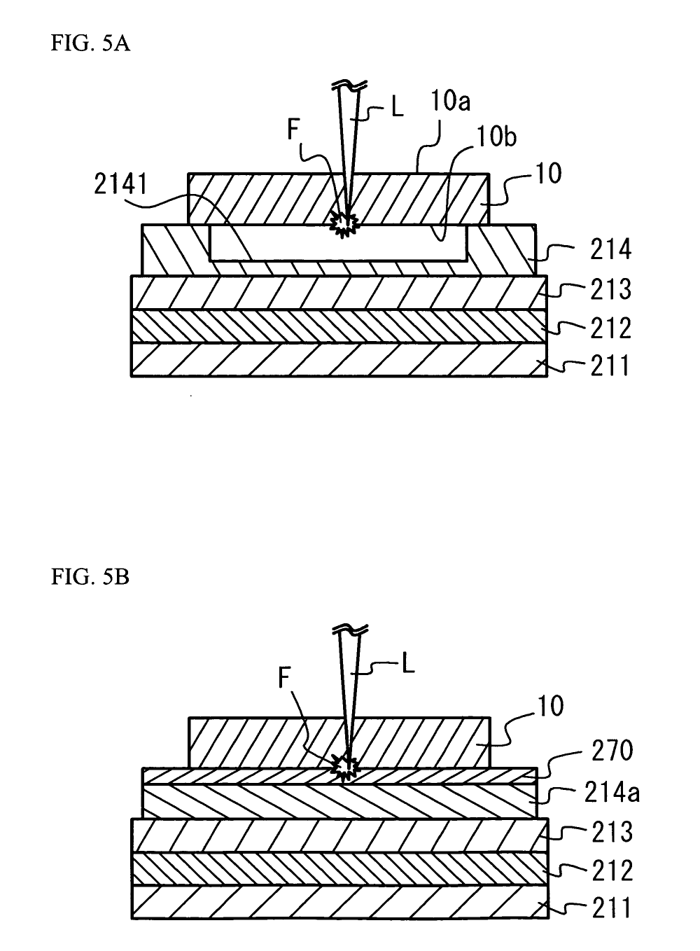

FIGS. 5A and 5B are explanatory views of a state of the laser beam focused on the second surface 10b. In FIGS. 5A and 5B, the substrate 10 is simplified. As illustrated in FIG. 5A, the laser beam L is focused on the second surface 10b of the substrate 10. As mentioned above, since the laser beam L has the wavelength so as to pass through the second surface 10b and is focused on the second surface 10b by the collective lens 250, the energetic density of the laser beam L is increased, thereby forming the mark on the second surface 10b.

Herein, the substrate holder 214 is formed with a recess portion 2141 which avoids a contact with the second surface 10b. Therefore, even when the laser beam is irradiated to the second surface 10b, the melting of the substrate holder 214 due to a thermal influence caused by the irradiation is prevented.

FIG. 5B is an explanatory view of a variation of the laser irradiation unit 200. FIG. 5B corresponds to FIG. 5A. A substrate holder 214a has a plate shape as illustrated in FIG. 5B. A laser absorption member 270 is arranged between the substrate holder 214a and the substrate 10. Therefore, even when the output of the laser oscillator 230 is lower, the laser absorption member 270 absorbs the laser beam L so as to be heated, thereby forming the mark on the second surface 10b of the substrate 10. The laser absorption member 270 may be made of a metallic or a resin. In addition, a laser absorbent may be applied to the second surface 10b of the substrate 10. A laser absorption layer may be formed by sputtering or deposition.

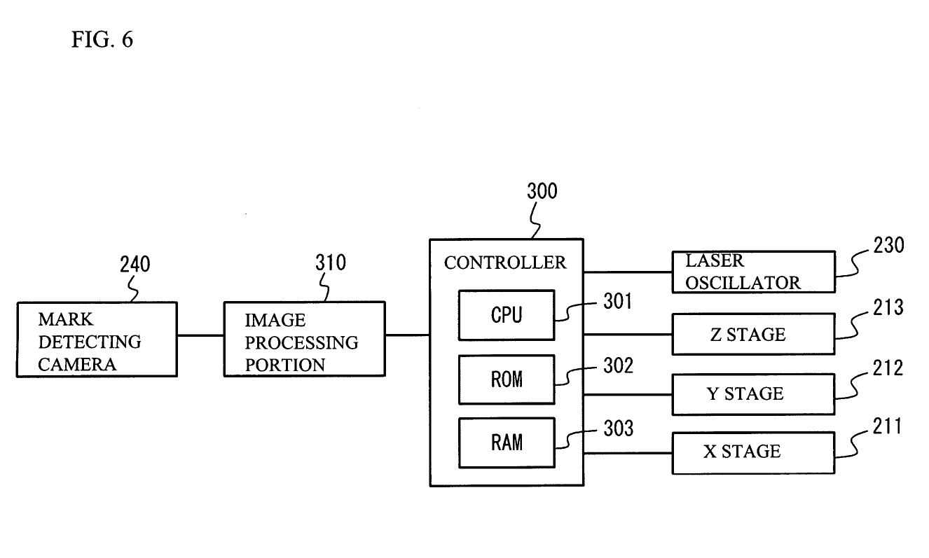

Next, a description will be given of a control unit of the laser irradiation unit 200. FIG. 6 is a functional block view of the laser irradiation unit 200. A controller 300 controls the whole operation of the laser irradiation unit 200. The controller 300 includes a CPU (Central Processing Unit) 301, a ROM (Read Only Memory), and a RAM (Random Access Memory) 303. The ROM 302 stores a program for irradiating the laser beam to the substrate 10. Additionally, the controller 300 may control only the operation of the laser irradiation unit 200, and may control the whole action of the alignment exposure unit 100 in addition to the laser irradiation unit 200.

The controller 300 controls the operations of the X stage 211, the Y stage 212, and the Z stage 213.

An image processing portion 310 processes image data outputted from the mark detecting camera 240 and detects the mark 12 formed on the second surface 10b of the substrate 10. The image processing portion 310 includes a CPU or the like.

The controller 300 detects the position coordinate of the alignment mark 17a on the first surface 10a on the basis of the information outputted from the image processing portion 310. When the position coordinate of the alignment mark 17a is detected, the controller 300 commands the X stage 211, the Y stage 212, and the Z stage 213 so that the alignment mark 17a is arranged coaxially with the mark detecting camera 240. Further, in this way, the controller 300 commands the Z stage 213 to control the height of the substrate 10 on the basis of thickness information, of the substrate 10, stored in the controller 300 beforehand. More specifically, the laser focused position that has been preset and the position of the second surface 10b are aligned.

Next, on the basis of the information outputted from the image processing portion 310, whether or not the alignment mark 17a is arranged on the optical axis of the mark detecting camera 240 is determined. When it is determined that the alignment mark 17a is arranged on the optical axis of the mark detecting camera 240, the controller 300 commands the laser oscillator 230 to irradiate the laser beam therefrom. This forms the mark 12 on the second surface 10b of the substrate 10.

Additionally, the controller 300 drives the X stage 211 and the Y stage 212 at a predetermined speed. In particular, the operations of the X stage 211 and the Y stage 212 are controlled such that the optical axis of the laser beam moves along the pattern of the alignment mark 17a. Therefore, the mark 12 having the same pattern of the alignment mark 17a is formed on the second surface 10b of the substrate 10.

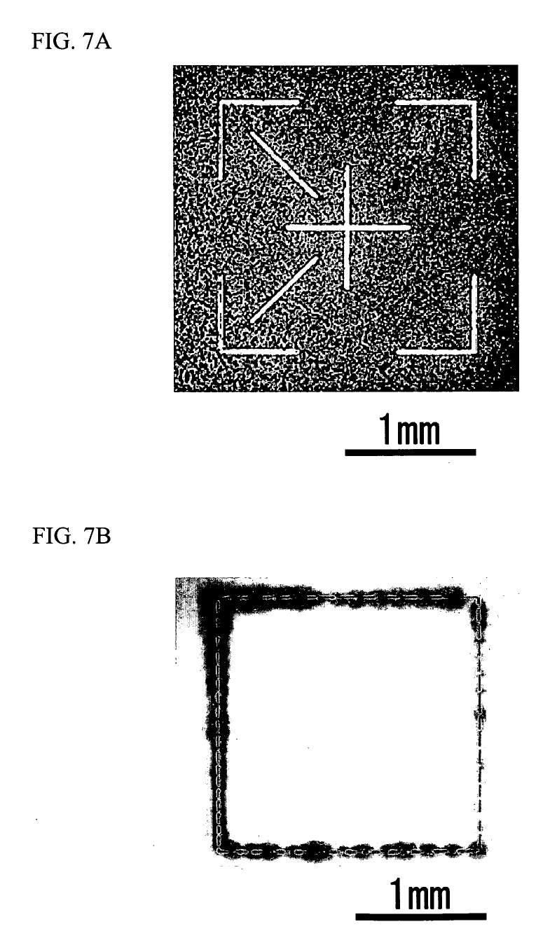

Next, a description will be given of the substrate after the laser irradiation is accomplished by the method mentioned above. FIGS. 7A and 7B are views of the substrate 10 after the laser irradiation. Additionally, an experiment was performed by using a SOI (Silicon On Insulator) substrate as the substrate 10. Specifically, regarding the SOI substrate, a support substrate had a thickness of 525 mm, a S102 interlayer had a thickness of 1 mm, and an active layer had a thickness of 10 mm. The active layer was formed on the first surface 10a side. A stainless steel (SUS304) was used as the laser absorption member 270 arranged between the substrate and the substrate holder 214a. A single mode optical fiber was used for the laser oscillator 230, and the wavelength is set to 1.48 mm. The output was set to 3W. An aspherical lens was used as the collective lens 250. In the aspherical lens, a focal length was 8 mm, and numerical aperture NA was 0.25. The laser scanning speed was 10 mm/minute.

FIG. 7A illustrates the resist pattern formed on a first surface of the substrate after the laser irradiation is accomplished. FIG. 7B illustrates the mark formed on the second surface of the substrate after the laser irradiation is accomplished. Additionally, FIG. 7B illustrates a state before the resist pattern is formed on the second surface of the substrate.

As illustrated in FIG. 7A, the alignment mark is formed on the first surface of the substrate. A laser mark is formed on the second surface of the substrate, as illustrated in FIG. 7B. The laser mark having a rectangular shape is clearly differential from the alignment mark formed on the first surface of the substrate. In this manner, the mark differential from the alignment mark is formed on the second surface of the substrate. Accordingly, the surfaces of the substrate can be determined by recognizing the laser mark formed on any one of the surfaces of the substrate.

The present invention is not limited to the specifically disclosed embodiments, but other embodiments and variations may be made without departing from the scope of the present invention.

The alignment mark may be formed on the substrate 10 by the exposure using negative resist film.

The laser irradiation unit 200 integrated with the alignment exposure unit 100 as the apparatus for producing a substrate has been described. However, this configuration is not limited, and the apparatus for producing a substrate may be the laser irradiation unit 200 alone.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method for producing a substrate, the method comprising:
forming an alignment mark on a first surface of the substrate;
detecting a position of the alignment mark; and
forming a mark by scanning and focusing a laser beam on a position, on a second surface of the substrate, corresponding to the position of the alignment mark, the laser beam having a wavelength so as to pass through the substrate.

2. The method for producing the substrate of claim 1, the further method comprising arranging a laser absorption portion on the second surface of the substrate.

3. An apparatus for producing a substrate, the apparatus comprising:
a camera detecting an alignment mark formed on a first surface of the substrate;
a laser oscillator irradiating a laser beam having a wavelength so as to pass through the substrate;
a lens focusing the laser beam on a position, on a second surface of the substrate, corresponding to a position of the alignment mark; and
a stage holding the substrate for movement and scanning a focused position of the laser beam relative to the substrate.

4. The apparatus for producing the substrate of claim 3, the apparatus further comprising: a dichroic mirror arranged concentrically with an optical axis of the camera and reflecting the laser beam to the substrate.

5. The apparatus for producing the substrate of claim 3 wherein the stage has a recess portion avoiding a contact with the second surface of the substrate.

6. A substrate comprising:
a first surface;
a second surface;
alignment marks respectively formed on the first surface and the second surface; and
a laser mark formed to overlap one of the alignment marks.
